(19) United States
(12) Patent Application Publication
(10) Pub. No.: US 2017/0049124 A1
(43) Pub. Date: Feb. 23, 2017

(54) METHOD FOR MANUFACTURING AERATED CHOCOLATE DOUGH AND METHOD FOR MANUFACTURING BAKED CHOCOLATE

(71) Applicant: MORINAGA & CO., LTD., Tokyo (JP)

(72) Inventors: Takashi ONO, Yokohama-shi, Kanagawa (JP); Hiroyuki WATANABE, Yokohama-shi, Kanagawa (JP); Naoki IEMOTO, Yokohama-shi, Kanagawa (JP)

(73) Assignee: MORINAGA & CO., LTD., Tokyo (JP)

(21) Appl. No.: 15/307,201

(22) PCT Filed: Oct. 6, 2014
(86) PCT No.: PCT/JP2014/076674

§ 371 Date: Oct. 27, 2016

(30) Foreign Application Priority Data
Jun. 4, 2014 (JP) 2014-115368

(51) Int. Cl. A23G 1/52; A23G 1/36

(52) U.S. Cl. CPC A23G 1/52; A23G 1/36; A23V 2002/00

(57) ABSTRACT

Provided is a method for manufacturing an aerated chocolate from a non-tempered type chocolate containing a non-tempered type non-cocoa fat and having reduced bloom, the chocolate being improved by uniform introduction of fine air bubbles. Also provided is a method for manufacturing baked chocolate, using the aerated chocolate obtained by the above manufacturing method. This method for manufacturing an aerated chocolate involves chilling a chocolate containing a non-tempered type non-cocoa fat from a completely molten state to a temperature 0.5-5° C. lower than the solidification temperature, reheating to a temperature 1-5° C. higher than said temperature, and providing aeration to bring the specific gravity to 0.3-1.1. Baked chocolate is obtained by forming the aerated chocolate obtained by said method to a prescribed shape, and baking the chocolate.

### TECHNICAL FIELD

The present invention relates to a method for manufacturing an aerated chocolate, and a method for manufacturing baked chocolate.

### BACKGROUND ART

Chocolate is a confection obtained by mixing cocoamass, sugar, powdered milk, cocoa butter, emulsifiers, flavorings, and the like, and refining and conching the mixture, which is then optionally tempered, and shaped. Tempering refers to a process which is carried out in order to minimize bloom (a mottled appearance, rough surface, and diminished texture caused by coarsening of fat crystals) during shaping of the chocolate. Specifically, tempering is carried out, for example, by a process of adding a chocolate powder which has been stored at low temperature as seeds to molten chocolate, which is then shaped at a temperature not greatly exceeding 30° C.; or, for example, by melting chocolate at 50° C., then first bringing the temperature down to about 28° C., and thereafter raising the temperature to about 32° C. Through tempering, fine stable crystal seeds are formed from the fat contained in the chocolate, and these serve as nuclei whereby the entire mass can be solidified into fine stable crystal shapes. The original texture of chocolate, which has a smooth, glossy surface, can be obtained thereby.

Among chocolate products there are those which, for reasons having to do with the manufacturing process, cannot undergo tempering, such as, for example, baked chocolate, or chocolate chips to be mixed into bakery goods. “Non-tempered type non-cocoa butter” is employed as the base fat in the chocolate used in such products. Non-tempered type non-cocoa butter does not exhibit notable crystal polymorphism, and therefore when more than a prescribed amount of non-tempered type non-cocoa butter is blended into a chocolate base fat, bloom is minimized despite the lack of a tempering process, and the problem of bloom does not occur, even when the material is baked (see Patent Documents 1 and 2 below).

Also included among chocolate products are those containing air bubbles for the purpose of imparting a light texture and the like. For example, Patent Document 3 below discloses the invention of a method for manufacturing a baked confection, characterized in that air bubbles are introduced into the chocolate, which is then shaped and baked until solid. It is disclosed that this manufacturing method produces a light, pleasantly chewy texture, and a structure that, at least on the surface, has a cookie-like hardness due to being baked, whereby such products, even when left at temperatures above the melting point, do not become sticky or lose shape, and can be eaten without the fingers being soiled. It is further disclosed that the shape retention of the shaped chocolate is improved due to the air bubble content, that heat penetration is improved, and that loss of shape during baking does not readily occur, thereby obviating the need to heat the product while packed into a mold, so that productivity can be improved.

### PRIOR ART DOCUMENT

### Patent Documents

[Patent Document 1] Japanese Laid-Open Patent Application No. 2005-261251
[Patent Document 2] Japanese Laid-Open Patent Application No. 2010-207198
[Patent Document 3] Japanese Laid-Open Patent Application No. 10-210934

### DISCLOSURE OF THE INVENTION

### Problems to Be Solved by the Invention

However, research conducted by the inventors has shown that with non-tempered type chocolate containing non-tempered type non-cocoa fat and having reduced bloom, when it is attempted to create air bubbles therein, it is difficult to uniformly introduce fine air bubbles into the chocolate, leading to the problem that the desired texture and the effect of reducing loss of shape are not consistently obtained. Another problem is that in some instances, large, non-uniform bubbles are created, and in instances in which the aerated chocolate is extruded, breaks in the chocolate may occur in sections where air bubbles are present, or the chocolate may not be extruded at a constant rate from the nozzle, preventing products from being manufactured in a consistent manner.

It is therefore an object of the present invention to provide a method for manufacturing an aerated chocolate from a non-tempered type chocolate containing a non-tempered type non-cocoa fat and having reduced bloom, wherein the chocolate is improved by uniform introduction of fine air bubbles. Another object is to provide a method for manufacturing baked chocolate, using the aerated chocolate obtained by said manufacturing method.

### Means to Solve the Problems

The method for manufacturing an aerated chocolate of the present invention is characterized in that a chocolate containing a non-tempered type non-cocoa fat is cooled from a completely molten state to a temperature 0.5-5° C. lower than the solidification temperature, reheated to a temperature 1-5° C. higher than said temperature, and aerated to bring the specific gravity to 0.3-1.1.

According to the method for manufacturing an aerated chocolate of the present invention, a chocolate containing non-tempered type non-cocoa fat is cooled from a completely molten state to a temperature 0.5-5° C. lower than the solidification temperature, whereby partial and incomplete micro-solids of fat components and the like are produced. Because the chocolate in this state is reheated to a temperature 1-5° C. higher than the aforementioned temperature, the fluidity of the chocolate increases while the micro-solids of fat components and the like are not completely melted, allowing the solids to become diffused and spread throughout the chocolate. This state is also one in which air bubbles are readily entrained. Because aeration in this state results in a specific gravity of 0.3-1.1, the partially and incompletely formed micro-solids of fat components and the like in the chocolate aid diffusion of air bubbles throughout the chocolate, preventing the air bubbles from coalescing into large air bubbles, or from being expelled from the chocolate. Therefore, a chocolate containing non-tempered type non-cocoa fat can be made to uniformly contain fine air bubbles, in a very efficient manner.

In the method for manufacturing an aerated chocolate of the present invention, it is preferable for the cocoa-derived fat content in the total fat content to be within a range at which bloom does not occur in the interior of the chocolate.

Also, in preferred practice, the cocoa-derived fat content in the total fat content is within a range at which bloom does not occur in the interior and on the surface layer of the chocolate.

The method for manufacturing baked chocolate of the present invention is characterized in that an aerated chocolate obtained by the aforedescribed method for manufacturing an aerated chocolate is formed to a prescribed shape, and baked.

### Advantageous Effects of the Invention

According to the present invention, a chocolate containing a non-tempered type non-cocoa fat is cooled from a completely molten state to a temperature 0.5-5° C. lower than the solidification temperature, reheated to a temperature 1-5° C. higher than said temperature, and aerated to bring the specific gravity to 0.3-1.1, whereby a chocolate containing non-tempered type non-cocoa fat can be made to uniformly contain fine air bubbles, in a very efficient manner.

### BRIEF DESCRIPTION OF THE DRAWINGS

FIG. 1 is a graph showing an example of results of measurement of the heat of solidification when chocolate samples are brought down in temperature at a rate of 5° C./minute from 50° C., and of the heat of melting when subsequently elevated in temperature, measured by a differential scanning calorimeter; and

FIG. 2 is a scatter plot of chocolates manufactured in Test Example 1, with the solid fat content (SFC) of non-tempered type non-cocoa fats A, B, and C at 20° C. plotted on the X axis, and the proportion of cocoa-derived fat with respect to the total amount of fat in the chocolate plotted on the Y axis.

### BEST MODE FOR CARRYING OUT THE INVENTION

Herein, “chocolate” is not limited to those defined by regulation and statute, and refers to all manner of fatty processed foods using cocoa mass, cocoa powder, cocoa butter, cocoa butter substitutes, and the like.

“Non-tempered type non-cocoa fat” refers to fats which make up chocolate, but which are not derived from cocoa beans and do not require tempering in order to prevent bloom in the chocolate. Specifically, these include trans acid type fats obtained by trans-isomerization hardening of a fractionated soft portion of palm oil or the like, or of a liquid oil such as soybean oil and the like; lauric acid type fats obtained from fats comprising glycerides that contain numerous lauric acid groups, such as coconut oil, palm kernel oil, and babassu oil, or fractionated oils of these fats; the asymmetric type glycerides 1,2-di-saturated fatty acid-3-mono-unsaturated fatty acid glycerides (SSU); and fats obtained by having these be present with the SUS-type glycerides triglycerides of 2-unsaturated fatty acid-1,3-di-saturated fatty acids.

Herein, “cocoa-derived fat” refers to fats derived from cocoa beans, specifically, cocoa butter which makes up chocolate and is obtained by extraction of the fat component from cocoa mass or cocoa beans. Cocoa mass normally includes a fat component of about 50-55 mass %.

Herein, “bloom” refers to partial or overall lightening of color of chocolate, to the extent of being visually noticeable.

Herein, “solid fat content” refers to a value measured by pulsed NMR.

The chocolate employed in the present invention may be any non-tempered type chocolate containing a non-tempered type non-cocoa fat, and having reduced occurrence of bloom, and commonly-employed chocolate, quasi chocolate, milk chocolate, quasi milk chocolate doughs, and the like can be adopted.

The chocolate can be prepared employing chocolate ingredients such as cocoa mass and/or cocoa powder, sugars, powdered milk, emulsifiers, cocoa butter and/or cocoa butter substitutes, flavorings, and other ingredients commonly used in chocolate, in accordance with the usual methods of mixing the ingredients, refining, and then conching. As sugars, it is preferable to employ, for example, table sugar, and optionally other sugars such as trehalose, lactose, and the like, or sugar alcohols and the like. As powdered milk there can be employed, for example, whole milk powder, skim milk powder, or the like. The use of lecithin as an emulsifier is preferred.

The method for manufacturing an aerated chocolate of the present invention is characterized in that a chocolate containing a non-tempered type non-cocoa fat is cooled from a completely molten state to a temperature 0.5-5° C. lower than the solidification temperature, reheated to a temperature 1-5° C. higher than said temperature, and aerated to bring the specific gravity to 0.3-1.1.

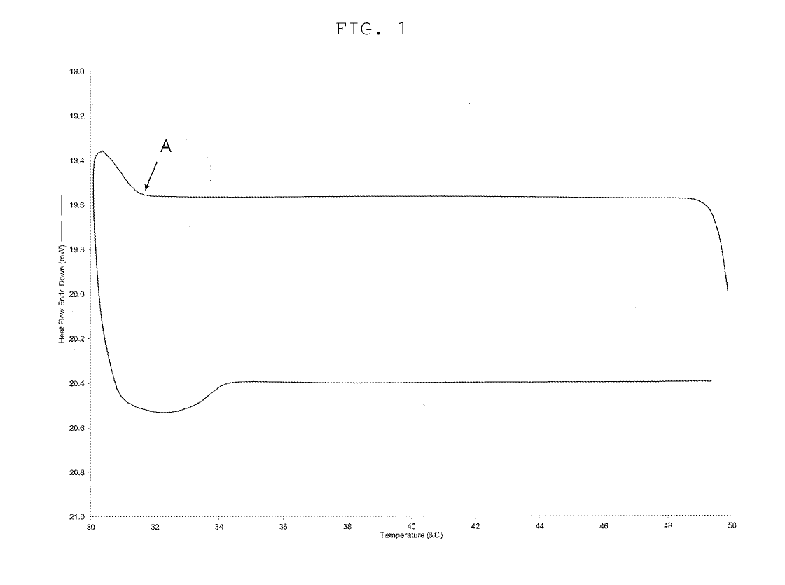

Here, the solidification temperature refers to the temperature at which a rise in the heat of solidification peak starts to be observed, when the heat of solidification occurring due to solidification of fat components and the like in a chocolate when the chocolate is brought down in temperature from a completely molten state is measured with a differential scanning calorimeter (DSC). More specifically, FIG. 1 shows an example of results of measuring the heat of solidification of 5 mg chocolate samples with a differential scanning calorimeter (trade name “Pyris1 DSC” made by PerkinElmer Japan), observed when the temperature is lowered at a rate of 5° C./minute from 50° C. The temperature of the portion shown by arrow A in FIG. 1 is the solidifation temperature.

There are no particular limitations as to the method for adjusting the temperature; for example, a method of placing a bowl containing the chocolate into constant-temperature water, a method employing marble, a method employing an automated tempering machine, or the like may be used. The preferred temperature conditions are to cool the chocolate containing a non-tempered type non-cocoa fat from a completely molten state to a temperature 0.5-5.0° C. lower than the solidification temperature, and to reheat the chocolate to a temperature 1-5° C. higher than said temperature. In preferred practice, the chocolate is cooled to a temperature 1.0-5.0° C. lower than the solidification temperature, and reheated to a temperature 1-4° C. higher than said temperature. Outside of the above ranges, the effect of creating uniform fine air bubbles in the chocolate is minimal, which is undesirable.

There are no particular limitations as to the aeration method, and any of various methods, such as methods involving stirring at high speed so as to entrain air, methods involving stirring while forcibly blowing in air with a pump or the like, or methods involving carrying out such stirring while heating, chilling, pressurizing, or depressurizing, can be employed. As an apparatus for doing so, for example, an aeration mixer, a Mondo mixer, an over mixer, or the like can be used.

In preferred practice, the specific gravity of the resulting aerated chocolate is 0.3-1.1. More preferably, the specific gravity of the resulting aerated chocolate 0.7-1.0. A lower specific gravity corresponds to a lighter texture. Also, the baked chocolate tends to be pleasantly chewy. The specific gravity can be measured by a method such as, for example, taking a level cup of 200 mL capacity of the chocolate in the fluid state prior to chilling, and measuring the mass thereof.

In preferred practice, aeration is carried out such that the average air bubble diameter in the chocolate in the chilled and solidified state is 10-100 μm, more preferably 10-50 μm, and still more preferably 10-25 μm. Adopting such a fine air bubble diameter gives a light, smooth texture when the chocolate is made into baked chocolate. Even if the specific gravity is within the aforementioned range, when the average air bubble diameter exceeds 100 μm, the texture becomes dry, which is undesirable. The average air bubble diameter can be measured by a method such as image analysis of a photomicrograph of the chocolate cross section. As a specific example, it is possible to split the chocolate upon being chilled to a solid, apply image analysis to a photomicrograph of the cross section thereof to measure a multitude of air bubble diameters in a standardized manner, and perform a statistical treatment on the air bubble diameters to calculate the average air bubble diameter.

In a preferred embodiment of the present invention, after reheating of the chocolate in the aforedescribed temperature conditioning, aeration is brought about while maintaining the same temperature or a temperature of within ±1° C. of the temperature, and more preferably while maintaining the same temperature or a temperature of within ±0.5° C. of the temperature. Outside of the aforementioned range, there is a risk that changes over time will occur in the chocolate once the temperature conditioning treatment has been carried out, and that the effect of introducing uniform fine air bubbles in the chocolate will be minimal.

As auxiliary ingredients, the aerated chocolate may contain, for example, minced nuts, puffed snacks, cookie bits, candy bits, chocolate chips, and the like. As minced nuts, it is preferable to use, e.g., almonds, peanuts, cashew nuts, hazelnuts, macadamia nuts, walnuts, or the like, minced to the desired size. As puffed snacks, it is preferable to use, e.g., corn, wheat, rice, or other ingredients puffed by pressure and heat and extruded; or starchy ingredients, such as wheat flour, rice flour, or various other starches, combined with auxiliary ingredients, seasonings, water, and the like, thermally gelled, and puffed.

The aerated chocolate can be shaped to the desired shape by known methods. There are no particular limitations as to the shaping method; for example, methods of shaping by placing into a mold (form), methods of extrusion to the desired shape from the die of an extruder and cutting, drop shaping methods in which the chocolate is dripped directly onto a conveyor or the like and solidifies, and the like are preferably employed.

The aforementioned baked chocolate can be manufactured by shaping the aerated chocolate to prescribed shape, and baking. In this case, it is preferable to adjust the extent of baking of the aerated chocolate and bring about heat denaturation of the surface to a state in which melting is not exhibited by heating, while the interior remains in a non-heat-denatured state. In so doing, the surface develops a crispy texture, and is not heat denatured or become sticky when held in the hand, whereas the interior has a smooth, light texture in which the original soft structure of chocolate remains.

Optionally, the aerated chocolate may be shaped, and then at least a portion of the chocolate surface enrobed. As enrobing materials it is preferable to use, for example, one of cookie dough form or cake batter form, made by adding water to a mixture of ingredients selected from wheat flour, starch, eggs, sugar, salt, powdered milk, shortening, and the like; however, it would suffice to simply dredge the product in a powdered mixture of wheat flour, starch, sugar, and the like. By enrobing the product with an enrobing material, shape retention during baking is further improved, and a thin coating of enrobing material is formed on the chocolate surface, giving an original appearance resembling the Japanese sweet kintsuba; also, the enrobing material makes it difficult for heat to penetrate to the interior. In so doing, the surface takes on a crispy, al dente texture through baking, while in the interior, a smooth, light texture that preserves the original soft structure of chocolate can be achieved.

Baking can be carried out, for example, using an oven, infrared grill, gas burner, microwave oven, or the like, and in the case of an oven is preferably carried out for 1-10 minutes at 200-270° C. By baking under these conditions, it is easy to obtain products having a suitably hard texture, while maintaining the original flavor of chocolate in the interior. The temperature at the center of the chocolate during baking is preferably about 90° C. In the case of an infrared grill, baking is preferably carried out for 1-10 seconds at a heater surface temperature of 400° C-1,200° C., with the distance between the heater and the surface of the chocolate set to 10-150 mm. An infrared grill is a baking apparatus equipped with infrared heaters able to conduct heat towards the interior of a product being baked, primarily through irradiation with infrared rays. When an infrared grill is employed in baking, a hard structure develops only in a shallow section of the surface layer, making it easy to obtain products having at the surface more noticeable a crispy texture, and pleasant chewiness. By carrying out forcible chilling with forced air or the like after baking, heat can be removed, and a baked chocolate obtained.

In preferred practice, the present invention is implemented in a chocolate in which the cocoa-derived fat content of the total amount of fat (excluding lecithin) is less than 0.3×N20+50 mass % (where N20 is the 20° C. solid fat content of the non-tempered non-cocoa-derived fat, excluding milk fat and lecithin), or the cocoa-derived fat content of the total amount of fat (excluding lecithin) is less than 0.3×N20+8 mass % (where N20 is the 20° C. solid fat content of the non-tempered non-cocoa-derived fat, excluding milk fat and lecithin). The reason is that, as will be shown by the examples given below, chocolate in which cocoa-derived fat content in relation to total fat satisfies these relational expressions typically tends, in the case of the first relational expression, to have reduced bloom in the interior of the chocolate, or in the case of the second relational expression to have reduced bloom in the interior and the surface layer, whereas with chocolate which does not satisfy these expressions, it tends to be difficult to introduce consistent air bubbles. By implementing the present invention, fine bubbles can be uniformly introduced into the chocolate.

### EXAMPLES

While the present invention is described in more specific terms through examples cited below, the present invention is not limited to these examples.

### Test Example 1

Table 1 shows recipes for the chocolates manufactured in the present test example. In Table 1, the middle rows show the amount of total fat (here and below, excluding lecithin), the amount of cocoa-derived fat component, and the amount of non-tempered type non-cocoa fat component (the amount does not include milk fat or lecithin) in the chocolate ingredients, as well as the proportion of cocoa-derived fat in total fat (mass %); the bottommost field in Table 1 shows whether the product was baked or not.

TABLE 1

| Ex. | Ex. | Ex. | Ex. | Ex. | Ex. | Ex. | Ex. | Ex. | Ex. | Ex. | Ex. |
|---|---|---|---|---|---|---|---|---|---|---|---|
| 1 | 2 | 3 | 4 | 5 | 6 | 7 | 8 | 9 | 10 | 11 | 12 |

Mass parts

| | | | | | | | | | | | | | |
|---|---|---|---|---|---|---|---|---|---|---|---|---|---|
| Chocolate | Sugar | 31 | 31 | 31 | 31 | 31 | 31 | 31 | 31 | 31 | 31 | 31 | 31 |
| ingredients | Trehalose | 10 | 10 | 10 | 10 | 10 | 10 | 10 | 10 | 10 | 10 | 10 | 10 |
| | Cocoa mass | 30 | 30 | 30 | 0 | 30 | 30 | 30 | 0 | 30 | 30 | 30 | 0 |
| | Cocoa powder | 0 | 0 | 0 | 15 | 0 | 0 | 0 | 15 | 0 | 0 | 0 | 15 |
| | Whole | 15 | 15 | 15 | 15 | 15 | 15 | 15 | 15 | 15 | 15 | 15 | 15 |
| | powdered | | | | | | | | | | | | |
| | milk | | | | | | | | | | | | |
| | Cocoa butter | 8 | 8 | 10 | 8 | 5 | 5 | 8 | 5 | 1.5 | 1.5 | 6 | 1.5 |
| | Non-tempered | 6 | 6 | 4 | 21 | 0 | 0 | 0 | 0 | 0 | 0 | 0 | 0 |
| | type fat A | | | | | | | | | | | | |
| | Non-tempered | 0 | 0 | 0 | 0 | 9 | 9 | 6 | 24 | 0 | 0 | 0 | 0 |
| | type fat B | | | | | | | | | | | | |
| | Non-tempered | 0 | 0 | 0 | 0 | 0 | 0 | 0 | 0 | 12.5 | 12.5 | 8 | 27.5 |
| | type fat C | | | | | | | | | | | | |
| | Lecithin | 0.5 | 0.5 | 0.5 | 0.5 | 0.5 | 0.5 | 0.5 | 0.5 | 0.5 | 0.5 | 0.5 | 0.5 |

Mass parts

| | | | | | | | | | | | | | |
|---|---|---|---|---|---|---|---|---|---|---|---|---|---|
| Fat | Cocoa- | 24.5 | 24.5 | 26.5 | 9.5 | 21.5 | 21.5 | 24.5 | 6.5 | 18 | 18 | 22.5 | 3 |
| components | derived fat | | | | | | | | | | | | |
| | Non-tempered | 6 | 6 | 4 | 21 | 9 | 9 | 6 | 24 | 12.5 | 12.5 | 8 | 27.5 |
| | type fat | | | | | | | | | | | | |
| | Total fat | 34.5 | 34.5 | 34.5 | 34.5 | 34.5 | 34.5 | 34.5 | 34.5 | 34.5 | 34.5 | 34.5 | 34.5 |

Mass %

| | | | | | | | | | | | | |
|---|---|---|---|---|---|---|---|---|---|---|---|---|
| % cocoa- | 71 | 71 | 76.8 | 27.5 | 62.3 | 62.3 | 71 | 18.8 | 52.2 | 52.2 | 65.2 | 8.7 |
| derived fat | | | | | | | | | | | | |
| in total fat | | | | | | | | | | | | |
| Baking Y/N | N | Y | Y | Y | N | Y | Y | Y | N | Y | Y | Y |

The chocolates of Examples 1-12 were manufactured using chocolate ingredients according to the recipes indicated in Table 1. Specifically, the chocolate ingredients were mixed, and refined and conched by the usual methods to obtain chocolate. The chocolates so obtained were shaped and chilled for 30 minutes at 10° C., to obtain chocolates. In cases in which baking was carried out, the obtained chocolate was placed in a stationary oven, baked at 200° C. for 3 minutes, then cooled at 10° C. for 10 minutes, to obtain baked chocolates.

Table 2 shows results of evaluations of bloom in the obtained chocolates and baked chocolates.

TABLE 2

| | | % cocoa- | | Bloom Y/N | |
|---|---|---|---|---|---|
| | | derived fat | | Surface | |
| | Recipe | in total fat | Baking | layer | Interior |
| Non-tempered | Ex. 1 | 71 | none | Y | N |
| type fat A | Ex. 2 | 71 | stationary | N | N |
| | | | oven | | |
| | Ex. 3 | 76.8 | stationary | N | Y |
| | | | oven | | |
| | Ex. 4 | 27.5 | stationary | N | N |
| | | | oven | | |
| Non-tempered | Ex. 5 | 62.3 | none | Y | N |
| type fat B | Ex. 6 | 62.3 | stationary | N | N |
| | | | oven | | |
| | Ex. 7 | 71 | stationary | N | Y |
| | | | oven | | |
| | Ex. 8 | 18.8 | stationary | N | N |
| | | | oven | | |
| Non-tempered | Ex. 9 | 52.2 | none | Y | N |
| type fat C | Ex. 10 | 52.2 | stationary | N | N |
| | | | oven | | |
| | Ex. 11 | 65.2 | stationary | N | Y |
| | | | oven | | |
| | Ex. 12 | 8.7 | stationary | N | N |
| | | | oven | | |

As shown in Table 2, when Example 1 and Example 2, Example 5 and Example 6, and Example 9 and Example 10, which contain ingredients according to identical recipes, are compared, it may be seen that in each case, in the unbaked products of Example 1, Example 5, and Example 9, bloom did not occur in the interior of the chocolates, but did occur on the surface layer. In the baked products of Example 2, Example 6, and Example 10, there was no occurrence of bloom on the surface layer after baking. This is presumably because even if bloom occurred on the surface layer of the chocolate, the bloom disappeared or was minimized by baking.

Looking at Example 3, which was manufactured on the basis of the recipe of Example 1 (Example 2), but with the included amount of cocoa butter increased by 2 mass parts, and the non-tempered type non-cocoa fat A decreased by the same amount, Example 7, which was manufactured on the basis of the recipe of Example 5 (Example 6), but with the included amount of cocoa butter increased by 3 mass parts, and the non-tempered type non-cocoa fat B decreased by the same amount, and Example 11, which was manufactured on the basis of the recipe of Example 9 (Example 10), but with the included amount of cocoa butter increased by 4.5 mass parts, and the non-tempered type non-cocoa fat C decreased by the same amount, bloom occurred in the interior of the chocolate in each case.

Meanwhile, in chocolates in which 15 mass parts of cocoa powder was included in place of 30 mass parts of cocoa mass, the added amount of non-tempered type non-cocoa fat was increased, and the amount of cocoa-derived fat with respect to the amount of non-tempered type non-cocoa fat was decreased (Example 4, Example 8, Example 12), bloom did not occur in either the surface layer or interior thereof. This was true even during examination prior to baking.

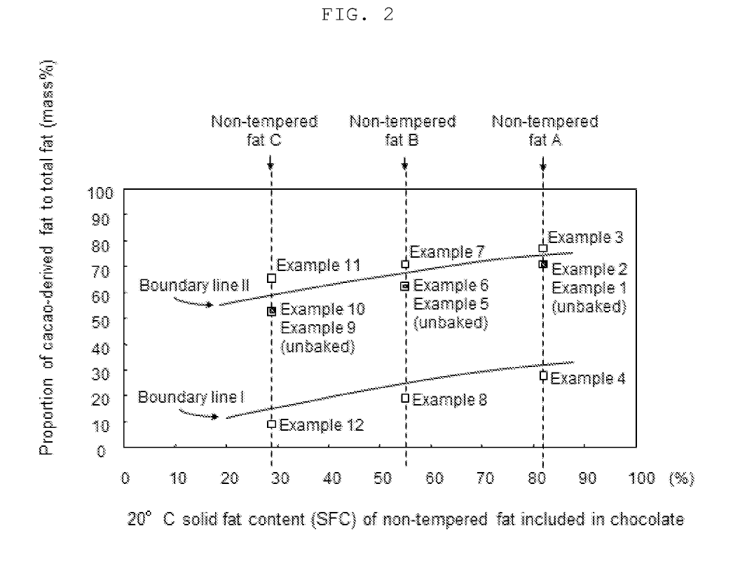

The relationship between the composition of a chocolate and the occurrence of bloom was examined on the basis of the aforedescribed results. To do so, the solid fat content (SFC) at 20° C. of the non-tempered type non-cocoa fats A, B, and C employed as chocolate ingredients was measured by pulsed NMR, following the usual method. A scatter plot was then created, plotting these values on the X axis, and plotting the proportion (mass %) of cocoa-derived fat with respect to total fat on the Y axis. The scatter plot is shown in FIG. 2.

As shown by the aforedescribed results, as compared with Example 1, Example 5, and Example 9 in which bloom occurred only on the chocolate surface layer and did not occur in the chocolate interior, in Example 3, Example 7, and Example 11 in which the respective contained amount of cocoa-derived fat was increased, and the contained amount of non-tempered type non-cocoa fat was decreased, bloom occurred in the chocolate interior in each case. It is thought that the reason is that because the contained amount of cocoa-derived fat was increased to the point of exceeding the upper limit boundary of compensation for the respective non-tempered type non-cocoa fat, bloom occurred not only on the surface layer of the chocolate, but also in the interior. Also, as compared with Example 1, Example 5, and Example 9 in which bloom occurred only on the chocolate surface layer, in Example 4, Example 8, and Example 12 in which the amount of cocoa-derived fat with respect to the amount of the respective non-tempered type non-cocoa fat was decreased, no bloom occurred in either the chocolate interior or the surface layer, irrespective of whether the product was baked or not. It is thought that the reason is that because the contained amount of cocoa-derived fat in this instance did not exceed the lower limit boundary of compensation for the respective non-tempered type non-cocoa fats, i.e., did not exceed the limiting point of miscibility with respect to the non-tempered type non-cocoa fat. Here, the limiting point of miscibility with respect to non-tempered type non-cocoa fat refers to a limiting point above which further increase in the included proportion of cocoa-derived fat to the total amount of fat in a chocolate containing non-tempered type non-cocoa fat will give rise to bloom on the chocolate surface layer. The limiting point of miscibility can be determined by carrying out tests to examine for bloom while gradually increasing the included proportion of cocoa-derived fat. In many cases, manufacturers who supply non-tempered type non-cocoa fat will provide users with miscibility limiting point information about their respective products.

From the preceding, a boundary line I indicating the boundary at which bloom can be assumed to occur in the chocolate surface layer if the included proportion of cocoa-derived fat to total fat is increased therebeyond (miscibility limiting point) can be drawn in the scatter plot of FIG. 2. Also, a boundary line II indicating the boundary at which bloom can be assumed to occur not only in the chocolate surface layer but also in the interior if the included proportion of cocoa-derived fat to total fat is increased therebeyond can be drawn.

Here, the boundary line I in the scatter plot of FIG. 2 substantially satisfies the relationship where the cocoa-derived fat content in the total fat content is 0.3×N20+8 mass % (where N20 is the 20° C. solid fat content of the non-tempered non-cocoa-derived fat, excluding milk fat and lecithin), and the boundary line II substantially satisfies the relationship where the cocoa-derived fat content in the total fat content is 0.3×N20+50 mass % (where N20 is the 20° C. solid fat content of the non-tempered non-cocoa-derived fat, excluding milk fat and lecithin). Therefore, the occurrence or non-occurrence of bloom can be predicted from the recipe of a chocolate on the basis of these relational expressions. However, more empirical boundary lines and relational expressions can certainly be set as appropriate, by increasing the number of test examples carried out close to the boundaries.

### Test Example 2

Table 3 shows recipes for chocolates manufactured in the present test example. In Table 1, the lower rows show the amount of total fat (here and below, excluding lecithin), the amount of cocoa-derived fat component, and the amount of non-tempered type non-cocoa fat component (the amount does not include milk fat or lecithin) in the chocolate ingredients, as well as the proportion of cocoa-derived fat in total fat (mass %).

TABLE 3

| Ex. 1-5 | | | | | | |
|---|---|---|---|---|---|---|
| Cmp. Ex. | Ex. | Ex. | Ex. | Ex. | Ex. | Ex. |
| 1-6 | 6 | 7 | 8 | 9 | 10 | 11 |

Mass parts

| | | | | | | | | |
|---|---|---|---|---|---|---|---|---|
| Chocolate | Sugar | 31 | 31 | 31 | 31 | 41 | 31 | 31 |
| ingredients | Trehalose | 10 | 10 | 10 | 10 | 10 | 10 | 10 |
| | Cocoa mass | 0 | 0 | 0 | 0 | 0 | 30 | 30 |
| | Cocoa powder | 15 | 15 | 15 | 15 | 0 | 0 | 0 |
| | Whole | 15 | 15 | 15 | 15 | 20 | 15 | 15 |
| | powdered | | | | | | | |
| | milk | | | | | | | |
| | Cocoa butter | 8 | 8 | 8 | 8 | 0 | 8 | 10 |
| | Non-tempered | 21 | 0 | 0 | 0 | 29 | 6 | 4 |
| | type fat A | | | | | | | |
| | Non-tempered | 0 | 21 | 0 | 0 | 0 | 0 | 0 |
| | type fat B | | | | | | | |
| | Non-tempered | 0 | 0 | 21 | 0 | 0 | 0 | 0 |
| | type fat C | | | | | | | |
| | Non-tempered | 0 | 0 | 0 | 21 | 0 | 0 | 0 |
| | type fat D | | | | | | | |
| | Lecithin | 0.5 | 0.5 | 0.5 | 0.5 | 0.5 | 0.5 | 0.5 |

Mass parts

| | | | | | | | | |
|---|---|---|---|---|---|---|---|---|
| Fat | Cocoa- | 9.5 | 9.5 | 9.5 | 9.5 | 0.0 | 24.5 | 26.5 |
| components | derived fat | | | | | | | |
| | Non-tempered | 21 | 21 | 21 | 21 | 29 | 6 | 4 |
| | type fat | | | | | | | |
| | Total fat | 34.5 | 34.5 | 34.5 | 34.5 | 34.5 | 34.5 | 34.5 |

Mass %

| | | | | | | | |
|---|---|---|---|---|---|---|---|
| % cocoa- | 27.5 | 27.5 | 27.5 | 27.5 | 0.0 | 71.0 | 76.8 |
| derived fat | | | | | | | |
| in total fat | | | | | | | |

The chocolates of Examples 1-11 and Comparative Examples 1-6 were manufactured using chocolate ingredients according to the recipes indicated in Table 3. Specifically, the chocolate ingredients were mixed, and refined and conched by the usual methods to obtain chocolate. The chocolates so obtained were completely melted at 50° C., chilled and then reheated under the temperature conditions shown in Tables 4-6 below, then placed in a pressurized-type mixer and stirred for 2 minutes at 2 atm in order to aerate the chocolate.

Table 4 shows results of evaluations of the state of air bubbles in the chocolates of Examples 1-5 and Comparative Examples 1-6. The solidification temperature of the chocolates of Examples 1-5 and Comparative Examples 1-6 (identical recipes) was measured with a differential scanning calorimeter (DSC), and found to be 31.7° C. The recipes of the chocolates of Examples 1-5 and Comparative Examples 1-6 did not exceed the boundary line I of the scatter plot of FIG. 2 shown in Test Example 1.

TABLE 4

| | Fat | | Temperature | | | Aeration | |
|---|---|---|---|---|---|---|---|
| | | Boundary | | | Re- | | Specific |
| | Type | line | Melt | Chill | heat | State | gravity |
| Ex. 1 | Fat A | Below I | 50 | 30 | 32 | ∘: | 0.78 |
| | (20° C. | | | | | contained | |
| | SFC of | | | | | uniform | |
| | 82%, | | | | | fine air | |
| | non- | | | | | bubbles | |
| Ex. 2 | lauric) | Below I | 50 | 31 | 33 | ∘: | 0.82 |
| | | | | | | contained | |
| | | | | | | uniform | |
| | | | | | | fine air | |
| | | | | | | bubbles | |
| Ex. 3 | | Below I | 50 | 27 | 29 | ∘: | 0.74 |
| | | | | | | contained | |
| | | | | | | uniform | |
| | | | | | | fine air | |
| | | | | | | bubbles | |
| Ex. 4 | | Below I | 50 | 30 | 31 | ∘: | 0.77 |
| | | | | | | contained | |
| | | | | | | uniform | |
| | | | | | | fine air | |
| | | | | | | bubbles | |
| Ex. 5 | | Below I | 50 | 30 | 35 | ∘: | 0.91 |
| | | | | | | contained | |
| | | | | | | uniform | |
| | | | | | | fine air | |
| | | | | | | bubbles | |
| Cmp. | | Below I | 50 | 30 | — | x: some | — |
| Ex. 1 | | | | | | large air | |
| | | | | | | bubbles | |
| | | | | | | formed | |
| Cmp. | | Below I | 50 | — | 32 | x: air | — |
| Ex. 2 | | | | | | bubbles | |
| | | | | | | could | |
| | | | | | | not be | |
| | | | | | | introduced | |
| Cmp. | | Below I | 50 | 31.5 | 33.5 | x: air | — |
| Ex. 3 | | | | | | bubbles | |
| | | | | | | could | |
| | | | | | | not be | |
| | | | | | | introduced | |
| Cmp. | | Below I | 50 | 26 | 28 | x: poor | — |
| Ex. 4 | | | | | | fluidity, | |
| | | | | | | could not | |
| | | | | | | be worked | |
| Cmp. | | Below I | 50 | 30 | 30.5 | x: some | — |
| Ex. 5 | | | | | | large air | |
| | | | | | | bubbles | |
| | | | | | | formed | |
| Cmp. | | Below I | 50 | 30 | 36 | x: air | — |
| Ex. 6 | | | | | | bubbles | |
| | | | | | | could | |
| | | | | | | not be | |
| | | | | | | introduced | |

As a result, as shown by the results of Examples 1-5, by chilling the chocolate from a completely molten state down to 0.7-4.7° C. below the solidification temperature of 31.7° C., then reheating to a temperature 1-5° C. higher than said temperature, and aerating the chocolate, uniform, fine air bubbles could be produced in the chocolate. In contrast to this, in Comparative Example 1 in which reheating treatment was not performed after chilling to 30° C., some large air bubbles were produced. In Comparative Example 2, in which the chocolate was merely chilled to 32° C., which is higher than the solidification temperature, substantially no air bubbles could be introduced. In Comparative Example 3, in which the chocolate was chilled to 0.2° C. below the solidification temperature, in Comparative Example 4, in which the chocolate was chilled to 5.7° C. below the solidification temperature, in Comparative Example 5, in which the temperature range from chilling to reheating was 0.5° C., and in Comparative Example 6, in which the temperature range from chilling to reheating was 6° C., either some large air bubbles were produced, or substantially no air bubbles could be introduced, or the fluidity of the chocolate was so poor that it could not be worked, so that in each case uniform, fine air bubbles could not be introduced into the chocolate.

Table 5 shows results for Examples 6-8, in addition to the aforedescribed results of Example 1. The solidification temperatures of the chocolates of Examples 6-8 were measured with a differential scanning calorimeter (DSC), and found to be 29.9° C., 29.2° C., and 25.1° C., respectively. The recipes of the chocolates of Examples 6-8 did not exceed the boundary line I of the scatter plot of FIG. 2 shown in Test Example 1.

TABLE 5

| | Fat | | Temperature | | | Aeration | |
|---|---|---|---|---|---|---|---|
| | | Boundary | | | Re- | | Specific |
| | Type | line | Melt | Chill | heat | State | gravity |
| Ex. 1 | Fat A | Below I | 50 | 30 | 32 | ∘: | 0.78 |
| | (20° C. | | | | | contained | |
| | SFC of | | | | | uniform | |
| | 82%, | | | | | fine air | |
| | non- | | | | | bubbles | |
| | lauric) | | | | | | |
| Ex. 6 | Fat B | Below I | 50 | 28 | 30 | ∘: | 0.81 |
| | (20° C. | | | | | contained | |
| | SFC of | | | | | uniform | |
| | 55%, | | | | | fine air | |
| | non- | | | | | bubbles | |
| | lauric) | | | | | | |
| Ex. 7 | Fat C | Below I | 50 | 27 | 29 | ∘: | 0.97 |
| | (20° C. | | | | | contained | |
| | SFC of | | | | | uniform | |
| | 29%, | | | | | fine air | |
| | non- | | | | | bubbles | |
| | lauric) | | | | | | |
| Ex. 8 | Fat D | Below I | 50 | 24 | 26 | ∘: | 0.85 |
| | (20° C. | | | | | contained | |
| | SFC of | | | | | uniform | |
| | 43%, | | | | | fine air | |
| | lauric) | | | | | bubbles | |

As a result, as shown by Examples 6-8 in addition to the aforedescribed results of Example 1, irrespective of differences among the several types of non-tempered type non-cocoa fats (lauric, non-lauric, and SFC), in each example, by chilling the chocolate to a temperature a prescribed temperature below the solidification temperature, reheating to a temperature a prescribed temperature above said temperature, and aerating the chocolate, uniform, fine air bubbles could be introduced into the chocolate.

Table 6 shows results for Examples 9-11, in addition to the aforedescribed results of Example 1. The solidification temperatures of the chocolates of Examples 9-11 were measured with a differential scanning calorimeter (DSC), and found to be 33.4° C., 29.1° C., and 28.6° C., respectively. The recipe of the chocolate of Example 9 did not exceed the boundary line I of the scatter plot of FIG. 2 shown in Test Example 1; the recipe of the chocolate of Example 10 exceeded the boundary line I but did not exceed the boundary line I of the scatter plot of FIG. 2 shown in Test Example 1; and the recipe of the chocolate of Example 11 exceeded the boundary line II of the scatter plot of FIG. 2 shown in Test Example 1.

TABLE 6

| | Fat | | Temperature | | | Aeration | |
|---|---|---|---|---|---|---|---|
| | | Boundary | | | Re- | | Specific |
| | Type | line | Melt | Chill | heat | State | gravity |
| Ex. 1 | Fat A | Below I | 50 | 30 | 32 | ∘: | 0.78 |
| | (20° C. | | | | | contained | |
| | SFC of | | | | | uniform | |
| | 82%, | | | | | fine air | |
| | non- | | | | | bubbles | |
| Ex. 9 | lauric) | Below I | 50 | 32 | 34 | ∘: | 0.74 |
| | | | | | | contained | |
| | | | | | | uniform | |
| | | | | | | fine air | |
| | | | | | | bubbles | |
| Ex. 10 | | Be- | 50 | 28 | 30 | ∘: | 0.86 |
| | | tween I | | | | contained | |
| | | and II | | | | uniform | |
| | | | | | | fine air | |
| | | | | | | bubbles | |
| Ex. 11 | | Above II | 50 | 27 | 29 | ∘: | 0.88 |
| | | | | | | contained | |
| | | | | | | uniform | |
| | | | | | | fine air | |
| | | | | | | bubbles | |

As a result, as shown by the results of Examples 9-11 in addition to the aforedescribed results of Example 1, irrespective of differences in the cocoa-derived fat content or the non-tempered type non-cocoa fat content in the total fat content in each example, it was possible, in all the examples, to introduce uniform, fine air bubbles into the chocolate by chilling the chocolate to a temperature a prescribed temperature below the solidification temperature, reheating to a temperature that was higher than said temperature by a prescribed temperature, and aerating the chocolate.

1. A method for manufacturing an aerated chocolate, characterized in that a chocolate containing a non-tempered type non-cocoa fat is cooled from a completely molten state to a temperature 0.5-5° C. lower than the solidification temperature, reheated to a temperature 1-5° C. higher than said temperature, and aerated to bring the specific gravity to 0.3-1.1.

2. The method for manufacturing an aerated chocolate according to claim 1, wherein the cocoa-derived fat content in the total fat content is within a range at which bloom does not occur in the interior of the chocolate.

3. The method for manufacturing an aerated chocolate according to claim 1, wherein the cocoa-derived fat content in the total fat content is within a range at which bloom does not occur in the interior and on the surface layer of the chocolate.

4. A method for manufacturing baked chocolate, characterized in that an aerated chocolate obtained by the method for manufacturing an aerated chocolate according to claim 1 is formed to a prescribed shape, and baked.

5. A method for manufacturing baked chocolate, characterized in that an aerated chocolate obtained by the method for manufacturing an aerated chocolate according to claim 2 is formed to a prescribed shape, and baked.

6. A method for manufacturing baked chocolate, characterized in that an aerated chocolate obtained by the method for manufacturing an aerated chocolate according to claim 3 is formed to a prescribed shape, and baked.
